(19) United States
(12) Patent Application Publication
(10) Pub. No.: US 2009/0174756 A1
(43) Pub. Date: Jul. 9, 2009

(54) Marking Device, Cigarette Rod Making Machine and Marking Method

(76) Inventor: Dirk Zehm, Paulushofen (DE)

Correspondence Address: FISH & RICHARDSON P.C., P.O. BOX 1022, MINNEAPOLIS, MN, 55440-1022, US

(21) Appl. No.: 11/571,657

(22) PCT Filed: Jun. 9, 2005
(86) PCT No.: PCT/EP2005/006220

§ 371 Date: Oct. 10, 2008

(30) Foreign Application Priority Data
Jul. 7, 2004 (DE) 10 2004 032 937.0

(51) Int. Cl. B41J 2/00

(52) U.S. Cl. 347/110

(57) ABSTRACT

A marking device for marking an object moved in a direction of movement is disclosed. The marking device comprises at least two printing devices designed for producing a predetermined or pre-determinable pattern and for contactlessly imprinting the object with the patterns sequentially whereby forming a complete pattern consisting of the individual patterns. The disclosure also relates to a cigarette rod making machine and to a method for contactlessly marking a moving object.

The invention involves a marking device for marking a moving object, a cigarette rod making machine, and a procedure for marking a moving object.

Traditionally, in printing equipment of industrial mass production, paper is imprinted by means of print rollers. For this purpose, paper which is, for instance, on the roll is unrolled, guided between two print rollers, imprinted, and, for instance, rolled up again or converted for further processing. During the actual printing procedure, a back presser print roller presses the paper against another print roller and copies the pattern to be reproduced on the paper. The pattern can be copied, for instance, by means of relief, piano graphic, and gravure printing, procedures during which very high printing speeds are achieved.

However, it is difficult to change the pattern to be printed or to print several different patterns on the paper. Traditionally, the pattern to be printed is changed by switching, for instance, the print roller or the roller system. For instance, in traditional offset-printing procedures, it is necessary to change a so-called plate cylinder or to change a printing plate attached to the plate cylinder.

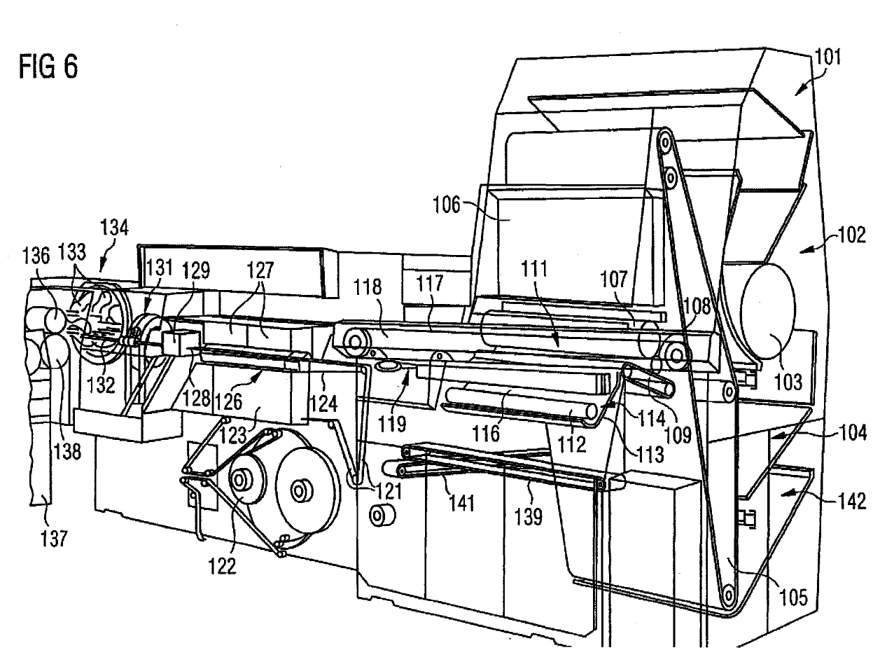

DE 101 30 225 A1, for instance, describes a printing unit for imprinting cigarette paper as part of a cigarette rod making machine from type PROTOS, as it is known in the tobacco processing industry. FIG. 6 shows a diagram of a cigarette rod making machine from type PROTOS. From a lock chamber 101, a pre-distributor 102 is fed with portions of tobacco fiber. An unloading roller 103 of the pre-distributor 102 supplements in controlled fashion a storage container 104 with tobacco from which a steep conveyor 105 extracts tobacco and feeds in controlled fashion an accumulation chamber 106. From the accumulation chamber 106, a pin roller 107 withdraws a steady amount of tobacco which is removed from the pins of the pin roller 107 by means of an impact roller 108 and thrown on a strewing cloth 109 rotating with constant speed. A tobacco fleece formed on the strewing cloth 109 is thrown into a view mechanism 111 which consists primarily of an air screen which filters out larger or heavier tobacco particles while the air channels all other tobacco particles into a hopper formed by a pin roller 112 and a wall 113. The pin roller 112 throws tobacco fibers in a tobacco duct 116 against a rod-making conveyor 117 in which the tobacco is held in a vacuum chamber 118 by means of suction and a tobacco rod is showered. An egalisator 119 removes excessive tobacco from the tobacco fiber rod, which is then placed on a synchronously controlled cigarette paper strip 121. The cigarette paper strip 121 is taken up by a bobbin 122, guided through a press work 123 and placed on a formatting conveyor 124. The formatting conveyor transports the tobacco rod and cigarette paper strip 121 through a formatting device 126 in which the cigarette paper strip 121 is folded around the tobacco rod with an overlapping edge which is supplied with glue in know fashion by an unembodied gluing device. Subsequently, the glue line is closed and dried with a tandem-seam iron 127. A cigarette rod 128 thus formed passes through a rod-density measuring instrument 129, which controls the egalisator, and is cut in double-long cigarettes 132 by means of a cutting device 131. By means of a transfer device 134 with controlled arms 133, the double-long cigarettes 132 are transferred to the reception bobbin 136 of a filter preparation machine 137. On the cutting bobbin 138 of the filter preparation machine, the double-long cigarettes are cut by means of a circular knife into single cigarettes.

Conveyors 139, 141 carry excessive tobacco in a container located underneath the storage container 104 from which the steep conveyor 105 again extracts returned tobacco.

If, for instance, the printing pattern has to be changed, that is, the printing plate has to be changed, the press work 123 can be completely exchanged which prevents the complicated change of individual printing plates.

Consequently, traditionally, several print rollers or printing plates that can be attached to the rollers, or entire roller print works, are provided to make changes so that a variety of different patterns can be printed. If the pattern has to be changed, the rollers or printing plates or roller print works can be exchanged. However, this requires an interruption of the printing procedure which results in downtimes of the printing equipment.

It is therefore the objective of the invention to provide a simple and flexible device for the purpose of marking an object. It is a further objective of the invention to provide a simple and flexible procedure for the purpose of marking an object. This objective is achieved by means of the marking device with the characteristics of claim 1, the cigarette rod making machine with the characteristics of claim 12, and the marking procedure with the characteristics of claim 13. Preferred embodiments are the subject of the dependent sub-claims.

It is an advantage of the invention at hand that a moving object can be marked at high speed. At the same time, the pattern can be changed without substantially changing or exchanging the marking device. It is particularly not required to make constructive changes on the marking device in order to change the pattern. Consequently, there are no downtimes of the marking device resulting from structural changes on the marking device.

Accordingly, it is a further advantage of the invention that the pattern can be changed quickly and simply, in particular during the operation of the marking device, which results in the fact that any a number of different patterns can be printed in a cost-efficient manner. In particular, there are no structural changes on the marking device required.

One aspect of the invention at hand involves the provision of a marking device to mark an object moved in the direction of movement comprising at least two printing devices designed for producing a predetermined or pre-determinable pattern and for contactlessly imprinting the object with the patterns sequentially whereby forming a complete pattern consisting of the individual patterns.

It is beneficial that it is not necessary to produce or use a printing plate. Instead, it is possible to produce any pattern by means of appropriate control or arrangement of at least two printing devices.

Furthermore, the moving object is operated contactlessly which prevents the occurrence of signs of wear, as is the case, for instance, with rotating print rollers, in particular at high speeds of the printing rollers.

In the preferred embodiment of the marking device of the invention at hand, each printing device prints in one printing direction, at which the printing direction is arranged to be inclined at various angles ranging from 0° to 180°, preferably basically vertical to the direction of movement of the moving object.

Preferably, the angle between printing direction and the direction of movement is measured from top view. In other words, printing direction and the direction of movement basically span a particular section, at which this section basically runs parallel to the surface of the object that is to be imprinted.

Especially preferred is a provided dissolution r of the complete pattern in the direction of movement of the moved object by using several printing devices through the equation

$$r = \frac{n \cdot f}{v} ,$$

at which v corresponds to relative speed between the printing devices and the object, f to the printing frequency of one printing device, and n to the number of printing devices.

Advantageously, it is possible to produce basically any pattern on the object by means of the preferred marking device of the invention at hand. As shown by the equation mentioned above, it is possible, with predetermined or pre-determinable resolution r, to imprint the moving object with predetermined or pre-determinable printing speed by selecting the number n of the printing devices used under generally constant printing frequency f. Analogously, at predetermined printing speed v, it is possible to increase the resolution of the complete imprinted pattern r by increasing the number n of printing devices. The same applies if the printing frequency f of the respective printing devices is changed. Consequently, the preferred marking device of the invention at hand is very flexible regarding the complete imprinted pattern, the resolution of the complete imprinted pattern, and/or the speed with which imprinted object moves past the printing device.

It is also possible to determine, for instance, the number of printing devices n required by using the equation from r, f, and v mentioned above.

Preferably, the moving object is cigarette paper, particularly preferred cigarette paper coming from a roll. Preferably, the cigarette paper comes basically from a long paper web, basically unconverted.

For instance, with the preferred marking device of the invention at hand, cigarette paper can be imprinted at a speed of

$$100 \frac{m}{min}$$

to approximately

$$1200 \frac{m}{min} ,$$

preferably at a speed of approximately

$$500 \frac{m}{min}$$

to approximately

$$900 \frac{m}{min} .$$

At the same time, it is possible to achieve a resolution in the direction of movement of preferably between approximately 1 point per mm (app. 25 dpi) and approximately 24 points per mm (app. 600 dpi), particularly preferred of between approximately 6 points per mm (app. 150 dpi) and approximately 18 points per mm (app. 455 dpi). However, it is also possible to print with a resolution of approximately 40 points per mm (app. 1,000 dpi).

Furthermore, it is especially preferred that the predetermined or pre-determinable patterns of two different printing devices are identical patterns.

Advantageously, it is possible to produce by means of the preferred marking device of the invention at hand a complete pattern consisting of identical patterns, as, for instance, several identical geometric shapes.

In a further preferred embodiment of the marking device of the invention at hand, the predetermined or pre-determinable patterns of two different printing devices are different patterns.

Advantageously, by means of this embodiment of the marking device of the invention at hand, it is possible to produce the complete pattern, in which case the complete pattern consists of a number of different patterns. For instance, it is possible to produce a complete pattern consisting of several combined geometric shapes. It is also possible, for instance, to print a brand name at which each printing device prints, for instance, one letter or part of a letter of the brand name.

Each printing device is able to print, for instance, lines, circles, and/or graphic patterns. It is also possible that the printing devices print number and/or symbols, such as mathematical characters.

Preferably, the marking device involves at least one reception device which is attached to the marking device in fixed or movable fashion.

For instance, the reception device can be attached to the marking device in such a way that the reception device is moving in relative fashion to the moving object by means of which the relative speed between the reception device and the moving object can be changed. It is, for instance, possible to attach the reception device to the marking device in movable, preferably rotating fashion. For instance, the reception device can involve a pivot-mounted wheel or pivot-mounted cylinder disc, on which or in which the printing devices are attached. By rotating the cylinder disc, preferably at least one of the two printing devices is brought into a position in which the moving object can be alternately imprinted.

In an especially preferred marking device, the printing devices are housed in a separate reception device.

For instance, in case the reception device or reception devices are attached to the marking device in movable fashion, each printing device can be moved individually in relative fashion to the movable object.

Preferably, all printing devices are housed in the same reception device.

Furthermore preferred at least the two printing devices are basically arranged in the direction of movement, especially preferred in a row in the direction of movement.

It is a further aspect of the invention at hand to provide a cigarette rod making machine with a preferred embodiment of the marking device of the invention at hand for marking the cigarette paper.

It is a further aspect of the invention at hand to provide a procedure for marking an object moved in a direction of movement by means of at least two printing devices, at which
The object is contactlessly imprinted by means of at least two printing devices
Each printing device produces a predetermined or pre-determinable pattern, and
A complete pattern is formed from the sequentially printed patterns.

In a preferred variant of the procedure of the invention at hand, each printing device prints in one printing direction at which the printing direction is arranged to be inclined at various angles ranging from 0° to 180°, preferably basically vertical to the direction of movement of the moving object.

It is furthermore preferred that an assigned dissolution r of the complete pattern in the direction of movement of the moved object by using several printing devices through the equation

$$r = \frac{n \cdot f}{v} ,$$

at which v corresponds to relative speed between the printing devices and the object, f to the printing frequency of one printing device, and n to the number of printing devices.

Preferably, the relative speed v lies between approximately

$$100 \frac{m}{min}$$

and approximately

$$1200 \frac{m}{min} ,$$

preferably between approximately

$$500 \frac{m}{min}$$

and approximately

$$900 \frac{m}{min} .$$

In another preferred variant of the procedure of the invention at hand, the moved object is cigarette paper and, before the marking process, the cigarette paper comes in the form of a long paper web and is basically unconverted.

With regard to other special embodiments of the invention-based cigarette rod making machine and the invention-based procedure for marking a moving object, reference is made to the respective description of the invention-based marking device.

Subsequently, the invention is described by means of drawings of preferred embodiments. It is shown

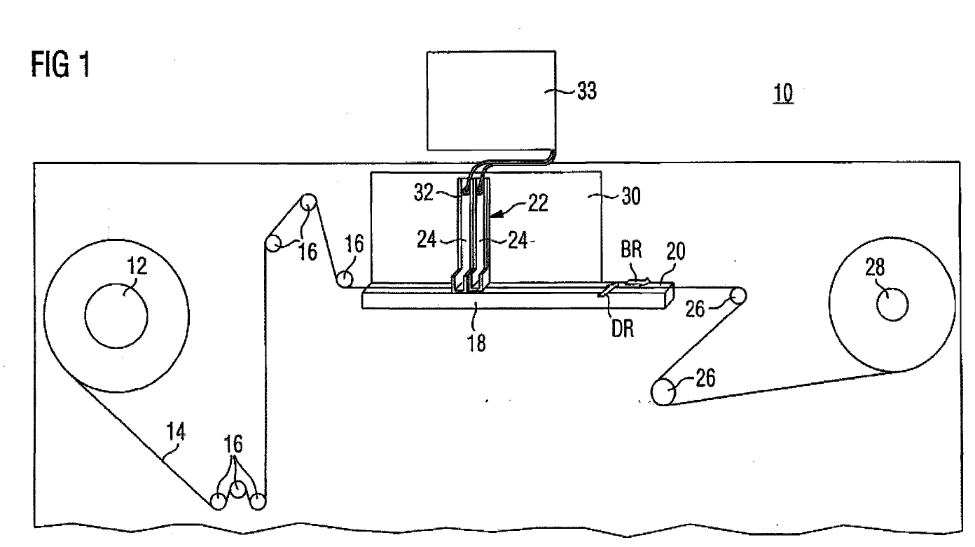

FIG. 1: A marking system with a marking device according to a preferred embodiment of the invention at hand;

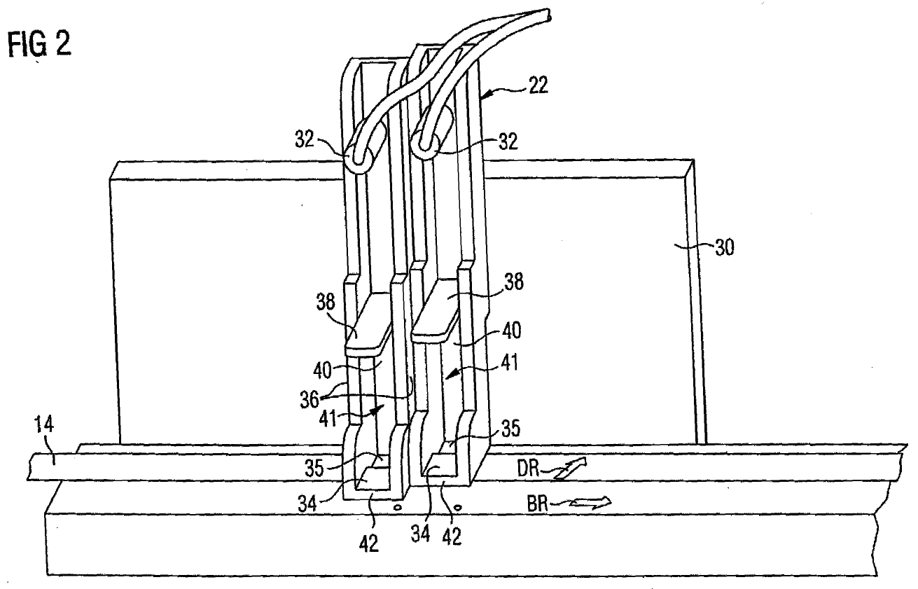

FIG. 2: A front view of the marking device of a preferred embodiment of the invention at hand;

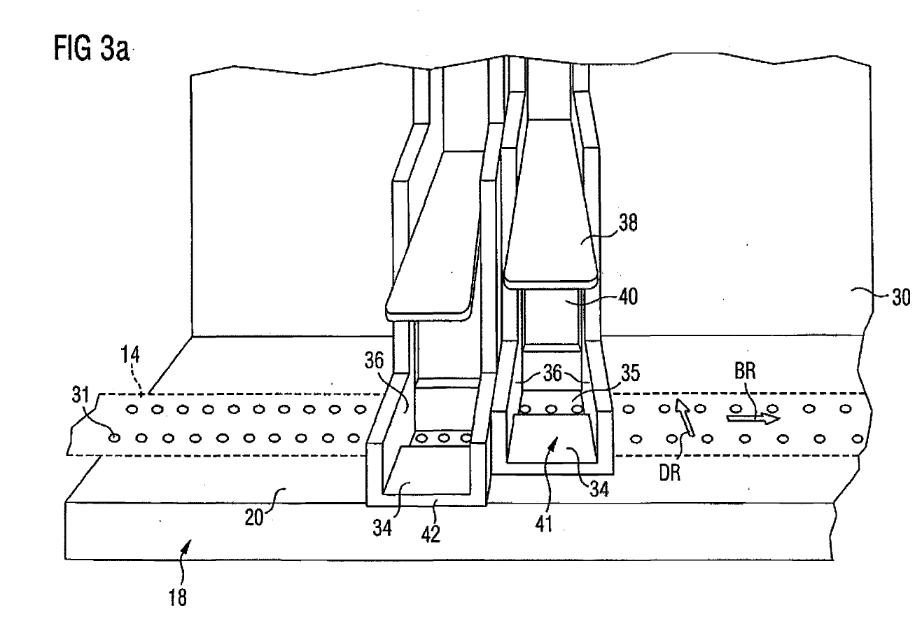

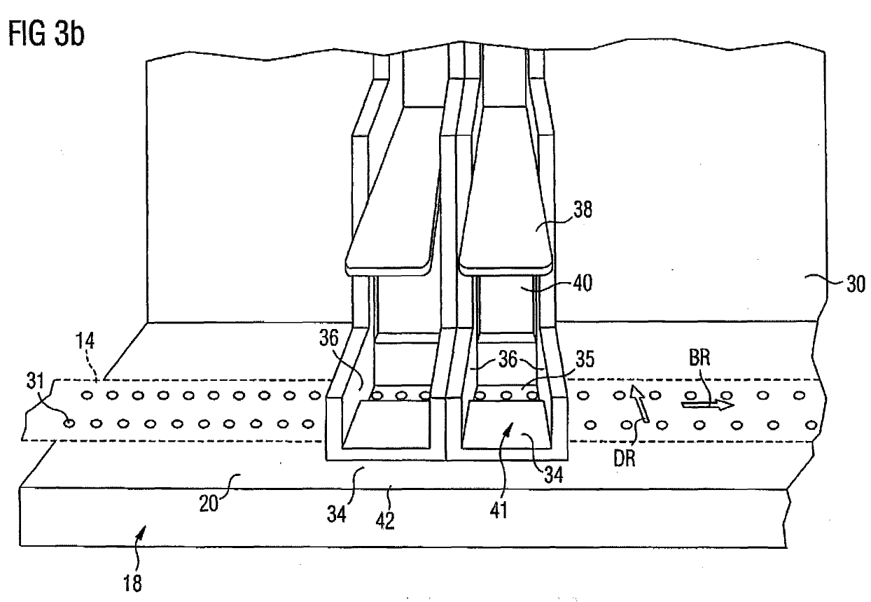

FIG. 3a: A top view of the marking device of a preferred embodiment of the invention at hand;

FIG. 3b: A top view of the marking device of a further preferred embodiment of the invention at hand;

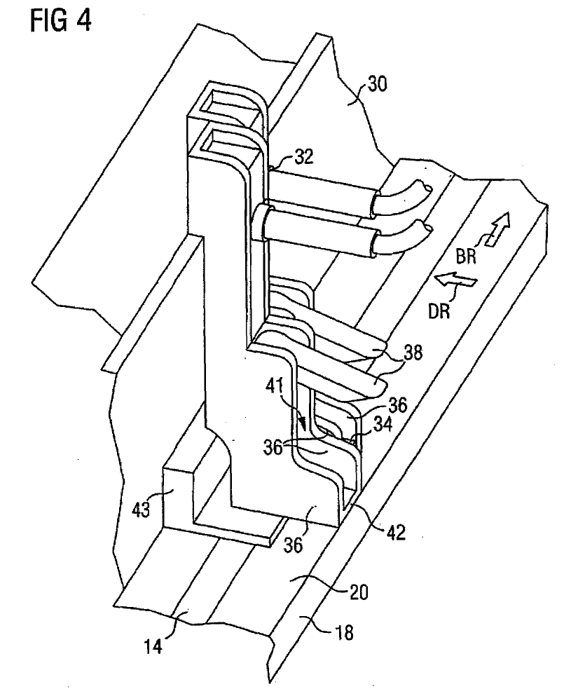

FIG. 4: A lateral view of a preferred embodiment of a marking device of the invention at hand;

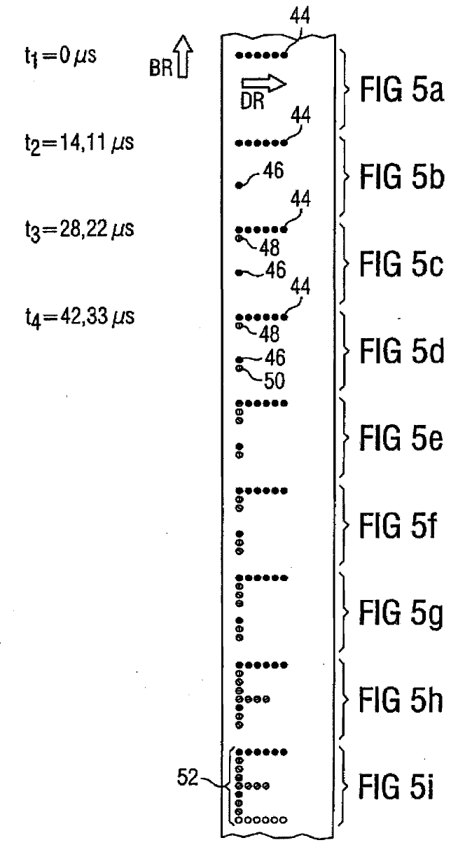

FIG. 5a through 5i: A diagram of the printing process of a marking device of a preferred embodiment of the invention at hand;

FIG. 6: A diagram of a cigarette rod making machine of the type PROTOS of the Hauni Company.

FIG. 1 shows a front view of a marking system 10 according to a preferred embodiment of the invention. Starting from an attachment 12, the cigarette paper 14 is guided to a printing table 18 via guide rollers 16. The cigarette paper 14 is guided on a surface 20 of the printing table 18 to a preferred embodiment of a marking device 22 of the invention at hand. For instance, the cigarette paper 14 is guided further in the direction of movement BR, basically along or on the surface 20 of the printing table 18, between the surface 20 of the printing table 18 and at least a reception device 24 of the marking device 22. At the same time, the cigarette paper 14 is imprinted by at least two printing devices (not shown), which are attached to the reception devices 24. Such printing devices can be, for instance, traditional ink jet printing cartridges as they are used in commercial ink jet printers. Consequently, the cigarette paper 14 is imprinted contactlessly, that is, without any contact between the marking device 22, or the printing part of the marking device 24, and the cigarette paper 14. The printing part of the marking device 24 can be, for instance, the ink discharge area of an ink jet printing cartridge. Preferably, the imprinted cigarette paper 14 has been converted with predetermined dimensions. However, it is also possible that the cigarette paper 14, after being imprinted, is guided to an attachment 28 via several further guide rollers 26 and there rolled up.

FIG. 2 shows a detailed view of a preferred embodiment of a marking device 22 of the invention at hand. The preferred marking device 22 involves, for instance, two reception devices 24, each of which are constructed in a way that basically one printing device (not shown) can be housed in it or preferably attached detachably. The two reception devices 24 are, for instance, inflexibly connected to each other and inflexibly attached to an area 30 of the marking system 10. It is also possible that the two reception devices 24 have a space in between them. Furthermore, it is possible the two reception devices 24 are flexibly connected with the marking device 22 or area 30 of the marking system 10. For instance, the reception devices 24 can be attached to a rotating cylinder disc or can be an integral part of the cylinder disc.

The cigarette paper 14 basically moves along the surface 20 of the printing table 18 in the direction of movement BR. At the same time, the cigarette paper 14 is moving between the marking device 22 and the surface 20 of the printing table 18, whereupon it has no contact with the printing devices of the marking device 22.

Preferably, the surface 20 of the printing table 18 has several openings 31. Preferably, the openings 31 are located in the areas of the surface 20 of the printing table 18 at which the cigarette paper moves along. By means of these openings 31, it is possible by controlling the pressure difference of the ambient pressure that the cigarette paper 14 is basically fixed into one printing direction DR. The printing direction DR basically runs parallel to the surface 20 of the printing table 18 and basically vertical to the direction of movement BR. Preferably, in comparison to the ambient pressure, negative pressure is produced at the openings 31. Because of the negative pressure, the cigarette paper 14 is basically pulled or sucked toward the surface 20 of the printing table 18. Basically, the cigarette paper 14 can be moved in the direction of movement BR, whereupon the cigarette paper 14 is basically fixed regarding the direction of movement. Because of the fact that the cigarette paper 14 is basically pulled or sucked toward the surface 20, the cigarette paper 14 is moving, at least in certain areas, basically coplanar to the surface 20 of the printing table 18, that is, the cigarette paper does not crumple, at least in certain areas but is, instead, planar, at least in certain areas. In particular, the cigarette paper 14 is basically planar in the area in which the printing process of the marking device 22 takes place.

The reception devices 24 also have respective connections 32 by means of which the printing devices (not shown) can be connected to a control device for data exchange, for instance, a computer or a so-called embedded system or embedded controller 33 (shown in FIG. 1). Furthermore, by means of the connections 32, the printing devices can be supplied with electricity.

In addition, each reception device has an opening 35 on the side 34 opposite to where the cigarette paper 14 is located. This side 34 is basically parallel to the surface 20 of the printing table 18. Preferably, the reception device 24 has also two sides 36 which run preferably parallel and which are basically vertical to the surface 20 of the printing table 18 and vertical to the direction of movement BR. Each reception device 24 can have also preferably a rotatable locking mechanism 38. In order to lock the locking mechanism 38, it can be rotated, for instance, in the direction of the surface 20, preferably basically parallel to the surface 20 of the printing table 18. In order to unlock the locking mechanism 38, it can be rotated, for instance, away from the surface 20 of the printing table 18, preferably basically parallel to the surface 30 of the marking device 22. The reception device 24 has also a rear side 40, which preferably runs basically parallel to the surface 30 of the marking system 10 and is preferably vertical to the surface 20 of the printing table 18. Side 34, sides 36, the locking mechanism 38, and the rear side 40 basically include a hollow space 41 in which the printing device is housed. The dimensions of the hollow space 41 are designed in a way that the printing device basically fits exactly into the hollow space 41 and it is not required that the hollow space 41 basically comes in cuboids form. Instead, the hollow space 41 is basically designed to measure up with the dimensions of the printing device. A protrusion (not shown) of the printing device engages into the opening 35 and the locking mechanism 38 basically prevents a movement of the printing device, especially a movement of the printing device out of the hollow space 41. It is not necessary that, in closed condition, the locking mechanism 38 basically runs parallel to the surface 20 of the printing table 18 and, in open condition, basically parallel to the surface 30. However, the locking mechanism 38 is designed in a way that the printing device can be simply or easily detached from its fixed condition in the hollow space 41. In particular, the locking mechanism 38 basically prevents a movement of the printing device. Preferably, this is achieved in that, by means of the locking mechanism 38, surface pressure is exerted on the printing device, which, in particular, presses the printing device into the hollow space. The locking mechanism 38 also has the characteristic that the printing device is fixed in the hollow space in detachable fashion. In other words, preferably, the locking mechanism 38 can be easily locked and unlocked by means of swiveling bearings of the locking mechanism 38. Consequently, the printing device can be easily fixed in the hollow space 41 or detached from the hollow space 41. Basically, the printing device is fixed in the hollow space 41 of the reception device 24 by inserting the protrusion (not shown) into the opening 35 and by means of the locking mechanism 38.

This has the advantage that it is easy to renew or replace the printing device. If, for instance, the printing device is a traditional ink cartridge, the ink cartridge can be exchanged if the ink supply is depleted or printing shall be done with a different color.

Preferably, the reception device 24 has a connection (not shown) which can be connected to control or regulating connections of the printing device. Preferably, by means of these connections 32, an electrical connection can be established between the printing device and the control or regulating device, for instance, the computer 33. Preferably, the computer, or embedded system or the embedded controller 33 controls or regulates the printing performance of each individual printing device.

The cigarette paper 14 is generally guided between the reception device 24 and the surface 20 of the printing table 18, whereupon the cigarette paper 14 passes through the opening 35 of the reception device 24 and is imprinted contactlessly by the printing device (not shown).

FIG. 3a shows a top view of the preferred marking device 22. In this preferred embodiment the two reception devices 24 are preferably offset in the direction of printing DR. In other words, the front edges 42 of side 34 are not aligned in the direction of movement BR but, instead, are arranged in offset fashion in the direction of printing DR. As a result, the printing areas of the individual printing devices are also offset in the direction pr printing DR. This increases the effective broadness of printable space to be used by the printing devices in the direction of printing DR.

FIG. 3b shows another preferred embodiment of the invention at hand. As shown in FIG. 3b, the reception devices 24 are arranged in such a way that the front edges 42 of side 34 are basically aligned in the direction of movement BR. As a result, the printing devices imprint basically the same areas on the cigarette paper 14. Otherwise, the embodiment shown in FIG. 3b corresponds basically to the embodiment shown and described in FIG. 3a.

Furthermore, with several reception devices 24 it is not necessary that all reception devices 24 are offset in the direction or printing DR, or that all reception devices 24 are basically arranged in aligned fashion in the direction of movement BR. Instead, it is also possible that a first number of reception devices 24 are arranged in offset fashion in the direction of printing DR and individual reception devices 24 of the remaining reception devices 24 are arranged basically in aligned fashion with the reception devices 24 of the first number in the direction of movement BR.

FIG. 4 shows a lateral view of the marking device 22. As described in FIG. 3a, the edges 42 of side 34 are not aligned in the direction of movement BR but are arranged in offset fashion in the direction of printing DR. As shown in FIG. 4, it is not necessary that the rear side 40 adjoins directly to the surface 30 but can also have a space in between them. It is also possible to arrange a guiding device 43 between the reception device 24 and the surface 20 of the printing table 18. This guiding device can be designed in a way that the cigarette paper 14 is directed past the printing device in a stabilized or precise manner. To this end, the cigarette paper can be guided between the guiding device 43 and the reception device 24. It is also possible to guide the cigarette paper 14 between the surface 20 of the printing table 18 and the guiding device 43. In this case, the guiding device 43 has an opening (not shown) that basically corresponds to opening 35. Basically, the cigarette paper 14 is imprinted contactlessly through these two openings.

Furthermore, it is possible to guide the cigarette paper 14 between two generally coplanar surfaces of the guiding device 43, at which one of the surfaces has an opening that is basically corresponding to opening 35. It is possible to imprint contactlessly the cigarette paper 14 through these two openings.

However, the guiding device 43 can also be designed in a way that keeps the reception device 24 in a fixed position, or that places it at a distance from the printing table 18 or the surface 30, or keeps it at a distance in a fixed potion.

FIGS. 5a through 5i depicts the printing procedure in a preferred embodiment of the marking device 22 at hand. In this preferred embodiment of the invention at hand, the marking device 22 consists of a total of 6 printing devices. In the example at hand, these are six customary ink jet printing cartridges HP 6154a of the company Hewlett & Packard, each of which can print with a frequency of approximately 12 kHz, that is, because of the relaxation required or refilling the capillaries with ink, one capillary jet can be activated by capillary effect after approximately 80 μs. Since the customary ink jet printing cartridge sprays ink on the cigarette paper by means of jets, it is possible, by means of customary ink jet printing cartridges to print basically dots which, because of the arrangement of the jets, are preferably arranged parallel to the printing direction DR. Consequently, the imprinted patterns are basically arranged from dots. For each HP ink jet printing cartridge, two jet rows are arranged in offset fashion toward each other with the possibility of a programmable printing release of each individual ink jet printing cartridge used in the preferred embodiment of the invention at hand. Therefore, depending on the parameterization, the individual dots merge more or less. Consequently, the patterns basically consist of individual dots. However, preferably, it is not possible to discern the individual dots separately because the dots are too close together and/or are bleeding into one another.

Each of the six printing devices is housed in a reception device 24 or positioned by means of it, and the reception devices 24 are arranged in the direction of movement BR. FIG. 1 gives a representation of two reception devices 24, that is, of two printing devices. Furthermore, FIGS. 5a through 5i show the direction of movement BR of the cigarette paper 14 and the direction of printing DR. FIG. 5a shows a section of the cigarette paper at a first point t1=0s. At the first point t1, the printing device prints a first pattern 44 on the cigarette paper. The first pattern involves six dots, which preferably are arranged basically vertical to the direction of movement BR of the cigarette paper 14. In other words, preferably the six dots are arranged basically parallel to the printing direction DR. The cigarette paper moves at a speed of

$$v = 360 \frac{m}{min}$$

along the direction of movement BR, moving under the marking device 22. Consequently, the place of the first pattern 44 moves in the direction of movement BR away from the first printing device and toward the second printing device.

FIG. 5b shows a second pattern 46, which is printed by the first printing device on the cigarette paper 14 at a second point t2, that is, for instance, 14, 11 μs after the point t1. The second pattern 46 is an individual dot.

FIG. 5c shows the cigarette paper 14 at point t3, that is, for instance, 28, 33 μs after t1. At point t3, the cigarette paper 14 has continued moving in the direction of movement BR so that the place of the first pattern 44 is located in the direction of movement BR basically behind the second printing device. The second printing device prints a third pattern 48 on the cigarette paper 14 next to the first pattern 44 in the direction of movement BR. In order to distinguish the third pattern 48 for instance form the second pattern 46, the third pattern 48 is depicted by means of a shaded circle in the direction of movement BR. Usually, the third pattern 48 (and all following patterns) consists also of individual dots, analogous to the first pattern 44 or the second pattern 46. In other words, because of using ink jet printing cartridges, all patterns basically consist of dots, as depicted in the pattern 44 and 46.

Analogous to FIG. 5b, FIG. 5d shows a fourth pattern 50, which is printed on the cigarette paper by the second printing device basically at a position behind the second pattern 46 in the direction of movement BR at a point t4, that is, for instance, 42, 33 μs after t1. In other words, after imprinting the third pattern 48, the cigarette paper 14 continues moving in the direction of movement and, as soon as the second pattern 46 is located basically behind the second printing device, the second printing device prints the fourth pattern 50.

A complete pattern 52 is produced from sequential printings of several individual patterns as further depicted in FIGS. 5e through 5i. FIG. 5i shows the complete pattern 52, in this instance the letter E, which is formed from individual patterns produced or printed by a number of printing devices. For instance, the individual patterns are printed next to each other. Consequently, the complete pattern 52 is produced by means of sequential printings of several individual patterns. However, the individual patterns are not restricted to one row in printing direction DR. Instead, it is also possible that the first pattern 44 includes also the third pattern 48 if it is possible to achieve the desired dissolution r with the speed v with which the cigarette paper 14 is moved and the printing frequency f of the ink jet printing cartridge under consideration of the equation mentioned above.

It is also possible for the printing devices to imprint areas several times, that is, for instance, that a printing device repeatedly imprints an area of the cigarette paper 14. However, it is also possible that different printing devices imprint or repeatedly imprint an area of the cigarette paper 14. For instance, in the case of color printing, an area of the cigarette paper 14 can be imprinted by several printing devices, which print, for instance, an identical pattern at which the colors used differ from one printing devices to the other. As this example shows, the number of patterns printed by an individual printing device is not restricted to two patterns. Instead, it is possible that a printing device is printing any number of individual patterns. For instance, several letters can be printed and a printing device can print merely a (partial) pattern of each letter. The dissolution in the direction of movement BR of an individual printing device, and thus also the distance of the individual patterns printed on the

cigarette paper 14 by the individual printing devices, is basically results from the equation

$${r}_{0} = \frac{f}{v}$$

(the distance of two individual patterns to each other in the direction of movement BR basically results from the inverse of the dissolution r). The dissolution in the direction of movement BR of the complete pattern 52 which is produced with the use of several n printing devices, can be increased in comparison to the dissolution of an individual printing device. With the use of several n printing devices, the dissolution r of the complete pattern 52 basically results in

$$r = \frac{n \cdot f}{v} .$$

Consequently, by attaching any number of individual printing devices, the dissolution r of the complete pattern 52 in the direction of movement BR can be basically changed or adjusted in any way. However, the dissolution of the complete pattern 52 in the direction of printing DR, that is, a direction basically vertical to the direction of movement BR is usually restricted by the dissolution of each individual printing device. The dissolution in printing direction DR is not dependent on the speed with which the cigarette paper 14 is moved relative to the marking device 22.

Furthermore, the individual reception devices 24 can be arranged in a way that the edges 32 in the direction of movement BR are not aligned, that is, that the reception device in the direction of printing DR, or the direction vertical to the direction of movement BR, is arranged in offset fashion. Consequently, the surface on the cigarette paper 14 which is being imprinted by the marking device 22, is advantageously increased beyond the printing surface of the individual printing devices. If the edges 42 are arranged basically aligned, the printable surface corresponds basically to the surface which can be imprinted by the individual printing device.

In a further preferred embodiment of the invention at hand, it is even possible to mark an object with characteristics different from paper. Advantageously, the object does not have to be guided between two print rollers as is the case with customary printing roll equipments. Instead, merely one side of the object has to be accessible for marking. For instance, it is possible that a cuboid-shaped object, preferably a box or something similar, is moved along the printing devices. Also, no contact needs to be between the marking device and the moved object. For instance, it is possible that a box on a conveyor is moved past the marking device and that the printing device is printing contactlessly the box.

Preferably, the preferred marking device 22 of the invention at hand can also be part of a complex marking system 10 as is used, for instance, in tobacco-processing industry. A drawing of such a marking system is shown in FIG. 1. For instance, such a system can be integrated in a production sequence of cigarette production.

The marking device 22 of the invention at hand is also not restricted to single-color printing. Instead, it is possible to imprint cigarette paper 14 multicolored or colorful. For instance, it is possible (as described above), that different printing devices imprint areas of the cigarette paper several times, printing, for instance, an identical pattern, and the colors of the inks of the different printing devices used differ from one another.

Furthermore, according to a preferred embodiment of the invention, a cigarette rod making machine has been provided in which the cigarette paper 14 is marked by means of a preferred embodiment of the marking device 22 of the invention at hand. Preferably, the cigarette rod making machine is equipped according to FIG. 6, in which, instead of the printing unit 123, a marking device 22 according to a preferred embodiment of the invention at hand is used. Additionally, reference is made to the description of a cigarette rod making machine of the type PROTOS according to DE 101 30 2245 A1, which is incorporated by reference in this application.

### PARTS LIST

10 Marking system
12 Attachment
14 Cigarette paper
16 Guide rollers
18 Printing table
20 Surface
22 Marking device
24 Reception device
26 Guide rollers
28 Attachment
30 Surface
31 Opening
32 Connections
33 Computer of embedded system or embedded controller
34 Side
35 Opening
36 Side
38 Locking mechanism
40 Rear side
41 Hollow space
42 Edge
43 Guiding device
44 First pattern
46 Second pattern
48 Third pattern
50 Fourth pattern
52 Complete pattern

1.-17. (canceled)

18. A marking device for marking a moving object moved in a direction of movement, comprising: at least two printing devices each designed (or producing a predetermined or pre-determinable pattern and for contactlessly imprinting the object with the patterns sequentially whereby forming a complete pattern consisting of the individual patterns.

19. The marking device according to claim 18, wherein each printing device prints in a direction of printing, at which the printing direction is inclined at an angle between 0° to 180°, preferably basically perpendicular to the direction of movement of the moving object.

20. The marking device according to claim 1, which provides a resolution r of the complete pattern in the direction of movement of the moved object by using several printing devices through the equation
$$r = \frac{n \cdot f}{v} ,$$
at which v corresponds to a relative speed between the printing devices and the moved object, f to a printing frequency of one printing device, and n to the number of printing devices.

21. The marking device according to claim 3, at which the relative speed v amounts to between approximately
$$100 \frac{m}{min}$$
and approximately
$$1200 \frac{m}{min} ,$$
preferably between approximately
$$500 \frac{m}{min}$$
and approximately
$$900 \frac{m}{min} .$$

22. The marking device according to claim 1, wherein the moving object is cigarette paper and preferably the cigarette paper consists basically of a long paper web, basically unconverted or unformulated.

23. The marking device according to claim 1, wherein the predetermined or pre-determinable patterns of two different printing devices are identical patterns.

24. The marking device according to claim 1, wherein the predetermined or pre-determinable patterns of two different printing devices are different patterns.

25. The marking device according to claim 1, wherein the marking device includes at least one reception device which is attached to the marking device in fixed or movable fashion.

26. The marking device according to claim 1, wherein each of the printing devices is housed in a separate reception device.

27. The marking device according to claim 1, wherein all printing devices are housed in a common reception device.

28. The marking device according to claim 1, wherein the plurality of printing devices arc arranged in one row in the direction of movement.

29. A cigarette rod making machine for the production of cigarettes including a marking device for marking a moving object moved in a direction of movement, the marking device comprising: at least two printing devices each designed for producing a predetermined or pre-determinable pattern and for contactlessly imprinting the object with the patterns sequentially whereby forming a complete pattern consisting of the individual patterns.

30. A method for marking an object moving in a direction of movement by means of at least two printing devices, the method comprising:
contactlessly imprinting the object by the at least two printing devices,
producing a predetermined or pre-determinable pattern with each printing device, and
sequentially imprinting the object with the predetermined or pre-determinable pattern to form a complete pattern on the object.

31. The method according to claim 30, wherein each printing device prints in one direction of printing, and wherein the printing direction is inclined at an angle between 0° to 180°, preferably basically perpendicular to the direction of movement of the moving object.

32. The method according to claim 30, wherein a resolution r of the complete pattern in the direction of movement of the moved object by using several printing devices is given through the equation
$$r = \frac{n \cdot f}{v} ,$$
at which v corresponds to a relative speed between the printing devices and the object, f to the printing frequency of one printing device, and n to the number of printing devices.

33. The method according to claim 32, wherein the relative speed v amounts to between approximately
$$100 \frac{m}{min}$$
and approximately
$$1200 \frac{m}{min} ,$$
preferably between approximately
$$500 \frac{m}{min}$$
and approximately
$$900 \frac{m}{min} .$$

34. The method according to claim 30, wherein the moving object is cigarette paper.

35. The method according to claim 34, wherein prior to marking, the cigarette paper comprises a long paper web that is unconverted or unformulated.

36. The marking device according to claim 22, wherein the cigarette paper comprises a long paper web that is unconverted or unformulated.
